(19) United States
(12) Patent Application Publication
(10) Pub. No.: US 2020/0325808 A1
(43) Pub. Date: Oct. 15, 2020

(54) PARTICULATE FILTER WITH VARIABLE CANAL GEOMETRY AND METHODS OF MANUFACTURING SUCH A FILTER

(71) Applicant: IFP Energies nouvelles, Rueil-Malmaison Cedex (FR)

(72) Inventor: Stephane RAUX, ORLIENAS (FR)

(21) Appl. No.: 16/305,616

(22) PCT Filed: May 9, 2017
(86) PCT No.: PCT/EP2017/061078

§ 371 Date: Nov. 29, 2018

(30) Foreign Application Priority Data
May 31, 2016 (FR) 16/54.910

(51) Int. Cl. F01N 3/022; B01D 46/24

(52) U.S. Cl. CPC F01N 3/0222; B01D 53/944; B01D 46/247

(57) ABSTRACT

The invention relates to a particulate filter for collecting particulate matter from the exhaust gases of an internal combustion engine, having a canal geometry that evolves along the entire length of the canal, such that: —the perimeter of the cross section of the canal decreases continuously from an open end (310) of the canal (370) as far as a reference cross section (350) of the canal, then increases continuously from the reference cross section as far as a closed end (360) of the canal, and —the surface area of the cross section of the canal decreases monotonously from the open end of the canal as far as the closed end. The closed ends are situated in the body of the filter near the outlet and inlet faces respectively for the inlet and outlet canals of the filter.

### FIELD OF THE INVENTION

The present invention lies in the field of the treatment of exhaust gases from combustion engines, in particular that of particulate filters for reducing the pollution generated by the engines.

General Context

Nowadays, regulatory constraints on pollutant emissions are increasingly harsh for diesel vehicles and other diesel-driven machines, notably as far as particulate emissions are concerned. Thus, diesel vehicles are generally equipped with particulate filters in order to comply with standards relating to pollutant emissions. The use of particulate filters is not limited to diesel vehicles, however, and it is expected that in the future such particulate filters will be integrated increasingly frequently into the exhaust lines of gasoline vehicles.

The particulate filter used in the exhaust line of an internal combustion engine makes it possible to retain the particles present in the exhaust gases and thus prevent them from being discharged into the atmosphere. The particles are mostly soot particles (carbon compounds). They can also comprise inorganic compounds originating from engine wear or contained in lubricants and the additives thereof or in fuels. These inorganic compounds form ash which remains in the filter and thus accumulates during the lifetime of the engine. In some cases, the filter can also include a catalytic formulation for treating certain pollutant emissions that are present in gaseous form in the exhaust gases, such as unburned hydrocarbons (HC), nitrogen oxides (NOx) or carbon monoxide (CO), in order to convert them into less harmful gases. This filter generally has to be regenerated periodically in order to eliminate the particles that have built up during filtering phases and thereby to maintain all the filtering capabilities thereof. The regeneration operations consist in burning the soot particles: the temperature of the filter is typically increased to around 450° C. to 600° C., generally by increasing the richness value of the exhaust gases that pass through without the richness value of 1 being reached, and an oxidizing composition of these same gases is obtained in order to realize the combustion of the particles retained in this filter. The particulate filter should thus be capable of withstanding high thermal and mechanical stresses, be resistant to the corrosion caused by the exhaust gases, withstand the shocks and vibrations associated with the movement of the vehicle, and generally be as compact as possible.

The particulate filter conventionally consists of a ceramic substrate having a honeycomb-type structure, as shown in FIG. 1A, often formed by extrusion of a paste made of a material in the form of particles, typically made of ceramic, having a plasticity that is adequate for this type of manufacturing. The substrate of the filter 1 is made up of an assembly of adjacent channels (2, 3) that extend between an inlet face 4 and an outlet face 5 for the exhaust gases, said channels being disposed parallel to one another and being separated from one another by common walls 6, in the manner of a honeycomb. The axis X represents the main flow axis of the exhaust gases. The channels extend in an elongate manner along this axis. The channels are closed off by plugs 7 at one of their ends, such that the exhaust gases (indicated by arrows) that enter channels that have been left open only at the inlet face are forced to pass through the porous walls 6 in common with the adjacent channels that have been left open only at the outlet face 5 so as to exit again through this outlet face. FIG. 1B is a schematic front view of the inlet 4 of a particulate filter 1 according to this example of a standard structure. The identical channels have a section of square shape, are disposed side by side, forming a grid pattern on the inlet face 4 of the filter. Some of these channels are plugged (plugs indicated by hatching) while others are open, forming a checkerboard pattern. The channels that have an opening at the inlet face are plugged at their other end at the outlet face and thus form what are referred to as inlet channels 2, through which the exhaust gases enter the filter in order to exit through the adjacent channels that are plugged at the inlet face and open at the outlet face of the filter, these being referred to as outlet channels 3, passing through the porous walls separating the inlet channels from the adjacent outlet channels. The thickness of the walls separating the adjacent channels is not indicated in FIG. 1B.

This closing off of the channels at one or the other of their ends thus ensures that the exhaust gases necessarily pass through the porous walls separating the channels, guaranteeing the function of filtering the particles contained in the exhaust gases.

However, the presence of plugs in these structures poses a number of problems. Firstly, the plugs limit the useful area of the channels since the plugs inserted into the channels are in contact with a part of the surface of the filtering partitions of the channels, and as a result this part can no longer carry out its function of filtering the exhaust gases. Secondly, there may be a risk of the plugs breaking, resulting in a drastic reduction in the efficiency of the filter. Finally, the plugs at the inlet face of the filter contribute toward the generation of a pressure drop in the filter during operation, since they abruptly divert the lines of flow toward the inlet channels, generating viscous friction. This pressure drop has numerous harmful consequences during the use of the filter, notably causing a deterioration in the efficiency of the engine.

In order to do away with the use of plugs and the associated problems, the patent application WO94/22556 proposes a method for deforming individual ends of the channels, using an end piece that is pyramid-shaped for example, the channel then preserving its original geometry with a square cross section in the rest of the filter. This deformation results in closure of the channels at one of their ends, thereby ensuring that the channels are closed off for the operation of the filter as described above.

The patent application US2003/0041575 also addresses the challenges relating to the use of plugs and the associated problems, and proposes a similar method of deforming the ends of the channels, along a length of typically 1 to 5 mm, but with a notable difference, which is that the channels are not completely closed after deformation and that a small plug is formed by an additional step of application of a paste. Such an additional closing-off step makes it more complex to manufacture the filter, and some problems associated with the presence of plugs, even small ones, can remain.

The patent application US2004/0206062 also proposes closing the channels by deformation, but with a different geometry of the pressing tool, resulting in filters which still have plugs at one of the ends of the channels.

The patent application JP2002317618 proposes a filter intended to reduce the pressure drop, having an inlet face and an outlet face that are formed respectively by only the rectangular openings of the inlet channels and only the rectangular openings of the outlet channels, forming a grid with an offset of half a step between each opening. The channels have two lateral surfaces facing one another, which continue toward the inside, starting from one face of the filter and extending into the vicinity of the opposite face of the filter, in a triangular shape, the inner side of which narrows. The filter according to thus does not have plugs and the inlet and outlet faces limit the pressure drop. However, the disposition and the geometry of the channels do not make it possible to obtain a satisfactory filtering area.

Generally, a maximum filtration capacity for a minimum space requirement of the filter is desired.

### OBJECTIVES AND SUMMARY OF THE INVENTION

The present invention therefore aims to at least partially overcome the abovementioned problems of the prior art, and aims in particular to meet at least one of the following objectives:
providing a filter which makes it possible to limit the pressure drop during its operation, while improving the rate of capturing of particles,
providing a compact filter, of limited weight and space requirement,
providing a simple method for manufacturing such a filter.

Thus, in order to achieve at least one of the above objectives, inter alia, the present invention proposes, according to a first aspect, a particulate filter for collecting the particles of exhaust gases from a combustion engine, said filter having a (monolithic) body made of porous material that extends in an elongate manner along an axis X, said body comprising:
an inlet face through which the exhaust gases enter the filter,
an outlet face through which the exhaust gases exit the filter again,
a plurality of inlet channels and outlet channels extending between the inlet face and the outlet face parallel to the axis X, each inlet channel being separated from an adjacent outlet channel by a common filtering wall that is able to allow through the exhaust gases, in order to form a honeycomb-type structure. The inlet and outlet channels each have:
an open end with a cross section that is square orthogonally to the axis X,
a closed end,
a reference cross section that is square orthogonally to the axis X, situated between said open and closed ends, preferably situated halfway between the inlet face and the outlet face, each of the four vertices of the reference cross section being common to two inlet channels and two outlet channels, and the four vertices of the square reference cross section having an unchanging position for every section of the channel orthogonally to the axis X, the open ends of the inlet channels being contiguous at the inlet face and the open ends of the outlet channels being contiguous at the outlet face, said open ends forming a grid pattern.

The geometry of each inlet and outlet channel is not constant along the entire length of the channel along the axis X, such that, for each inlet and outlet channel:
the perimeter of the section of the channel decreases continuously from the open end of the channel to the reference cross section of said channel, and then increases continuously from said reference cross section to the closed end, and
the area of the section of the channel decreases uniformly along the axis X from the open end of the channel to the closed end, where said area is zero, said closed end being situated in the body of the filter close to the outlet face for the inlet channel and being situated in the body of the filter close to the inlet face for the outlet channel.

Preferably, each inlet and outlet channel has a polygonal section of order 4n in every plane orthogonal to the axis X between the open end and the reference cross section, for the one part, and between the reference cross section and the closed end, for the other part, n being an integer preferably between 2 and 4.

The polygonal section of order 4n may form a convex polygon between the open end and the reference cross section, and form a concave polygon between the reference cross section and the closed end.

According to one embodiment, the section of the inlet and outlet channels is octagonal orthogonally to the axis X between the open end and closed end of each channel, except for the reference cross section.

According to one embodiment, the section of the inlet and outlet channels is dodecagonal orthogonally to the axis X between the open end and closed end of each channel, except for the reference cross section.

According to one embodiment, the section of the inlet and outlet channels is hexadecagonal orthogonally to the axis X between the open end and closed end of each channel, except for the reference cross section.

Preferably, for each inlet and outlet channel, the square section of the open end is obtained by homothetic transformation by a positive ratio k, k preferably being equal to the root of 2, and by rotation, preferably through an angle of 45°, of the square reference cross section.

Preferably, the closed end of the inlet channels is situated in the body of the filter at a distance yₑ from the outlet face, and which the closed end of the outlet channels is situated in the body of the filter at a distance yₛ from the inlet face, the distances yₑ and yₛ being between 1 and 50 times the thickness of the walls.

According to one embodiment, the reference cross section of each inlet and outlet channel is contained in one and the same reference plane orthogonal to the axis X, said reference plane being situated halfway between the inlet face and the outlet face.

According to one embodiment, the perimeter and the area of the section of the channels evolve symmetrically on either side of the reference cross section.

The reference cross section of each inlet and outlet channel may be contained in one and the same reference plane orthogonal to the axis X, said reference plane being closer to the outlet face than to the inlet face.

According to one embodiment, the common filtering walls separating the inlet and outlet channels comprise a catalytic coating for the treatment of at least one compound contained in the exhaust gases, said compound being chosen from the following list: unburned hydrocarbons (HC), carbon monoxide (CO), nitrogen oxides (NOx), NH₃, SO₂, H₂S.

According to a second aspect, the present invention proposes a method for manufacturing a particulate filter according to the invention by stereolithography, wherein the body of the filter is constructed by solidifying a porous material in the form of successive layers by means of a stereolithography machine which reproduces a previously established digital 3D model of said filter body.

According to a third aspect, the present invention proposes a method for manufacturing a particulate filter according to the invention by 3D printing, wherein the body of the filter is constructed by deposition of a porous material in the form of successive layers by means of a 3D printer which reproduces a previously established digital 3D model of said filter body.

According to a fourth aspect, the present invention proposes a method for manufacturing a particulate filter according to the invention, wherein:
a filter body made of porous material that extends in an elongate manner along an axis X is obtained by extrusion, said filter body having a plurality of initial channels that extend parallel to the axis X and have a constant section that is square orthogonally to the axis X, and open at their two ends onto the inlet face and the outlet face of said body, and
said initial channels are deformed by introducing a penetrating tool into said initial channels through one of their ends at each of the inlet and outlet faces, and as far as a given point D along the axis X, at least as far as the middle of said body, so as to obtain the inlet and outlet channels of the filter according to the invention.

Preferably, the penetrating tool has a block provided with a set of polyhedral protrusions that extend in an elongate manner along one and the same axis W, said protrusions having a first square base and a second square base that are situated in parallel planes, the first base being in contact with said block, said first and second bases being connected by 4n facets, n being an integer preferably between 2 and 4, such that the section of the protrusion in a plane orthogonal to the axis W is in the form of an evolving irregular convex polygon of order 4n, preferably such that the perimeter of said section of the protrusion decreases continuously from the first base to the second base at the same time as the area of said section of the protrusion decreases uniformly from the first base to the second base, and the penetrating tool and the body of the filter are configured such that when the penetrating tool is applied to each of the inlet and outlet faces of the body of the filter, the protrusions pass into every other channel on each face in a checkerboard pattern.

Further objects and advantages of the invention will become apparent from reading the following description of particular exemplary embodiments of the invention which are given by way of nonlimiting example, with reference to the appended figures, described below.

### BRIEF DESCRIPTION OF THE FIGURES

FIGS. 1A and 1B, already described, are schematic diagrams depicting a particulate filter according to the prior art. FIG. 1A is a partial side view of the filter according to the prior art and FIG. 1B is a partial front view of the filter.

FIG. 2 is a partial front view of a particulate filter according to the invention.

FIGS. 3A, 3B, 3C, 3D, 3E, 3F and 3G illustrate a filter according to an embodiment with a hexadecagonal geometry. FIG. 3A shows the evolution of the section of a channel from the inlet to the outlet of the filter. FIG. 3D shows the evolution of the section of a channel from the inlet to the middle of the filter. FIGS. 3B/3E and 3C/3F are examples of cross sections of the filter, close to the inlet of the filter and around ¼ of the way along the filter from the inlet, respectively. FIG. 3G is a partial view of a longitudinal section of this filter.

FIG. 4 is a side view of an example of a protrusion of a tool used to manufacture the filter of hexadecagonal geometry by deformation of the channels.

FIGS. 5A, 5B, 5C, 5D, 5E, 5F and 5G illustrate a filter according to an embodiment with a dodecagonal geometry. FIGS. 5A and 5D show the evolution of the section of a channel from the inlet of the filter to the middle of the filter. FIGS. 5B/5E and 5C/5F are examples of cross sections of the filter, close to the inlet of the filter and around ¼ of the way along the filter from the inlet, respectively. FIG. 5G is a partial view of a longitudinal section of this filter.

FIG. 6 is a side view of an example of a protrusion of a tool used to manufacture the filter of dodecagonal geometry by deformation of the channels.

FIGS. 7A, 7B, 7C, 7D, 7E, 7F and 7G illustrate a filter according to an embodiment with an octagonal geometry. FIGS. 7A and 7D show the evolution of the section of a channel from the inlet of the filter to the middle of the filter. FIGS. 7B/7E and 7C/7F are examples of cross sections of the filter, close to the inlet of the filter and around ¼ of the way along the filter from the inlet, respectively. FIG. 7G is a partial view of a longitudinal section of this filter.

FIG. 8 is a side view of an example of a protrusion of a tool used to manufacture the filter of octagonal geometry by deformation of the channels.

FIG. 9 is a diagram illustrating the evolution of the perimeter of the section of a channel of the filter from the inlet to the outlet of the filter, for different geometries of channels according to the invention and for a channel of square section according to the prior art.

FIG. 10 is a diagram illustrating the evolution of the area of the cross section of a channel of the filter from the inlet to the outlet of the filter, for different geometries of channels according to the invention and for a channel of square section according to the prior art.

FIG. 11 is a side view of a channel according to another embodiment of a filter of asymmetric structure.

FIG. 12 is a partial side view of an inlet channel surrounded by four outlet channels of the asymmetric filter illustrated in FIG. 11.

In the figures, the same references denote identical or analogous elements.

### DESCRIPTION OF THE INVENTION

The present invention proposes a particulate filter for collecting the particles of exhaust gases from a, diesel or gasoline, internal combustion engine. The filter is thus typically used as a pollution-control device on an exhaust line of an internal combustion engine.

In operation, the filter traps the particles present in the exhaust gases that pass through it. It can also treat certain compounds of the unburned hydrocarbons (HC), carbon monoxide (CO) or nitrogen oxides (NOx) type, or for example ammonia (NH₃), sulfur dioxide (SO₂) or hydrogen sulfide (H₂S), which are contained in the exhaust gases, in order to convert them into less harmful compounds, when the filter comprises a catalytic formulation.

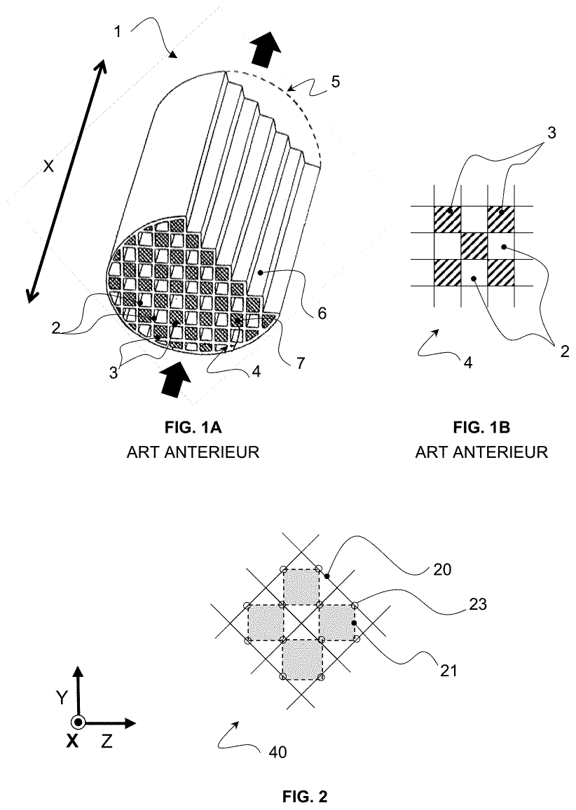

The filter has a body made of porous material that extends in an elongate manner along an axis X, which corresponds to the main flow axis of the exhaust gases in the filter. The body of the filter thus forms a monolith, having an inlet face through which the exhaust gases enter the filter and an outlet face through which the exhaust gases exit the filter again, as is the case for the prior art filter shown in FIG. 1A.

The body of the filter has a plurality of inlet channels and outlet channels, which extend between the inlet face and the outlet face of the filter, parallel to the axis X. Each inlet channel is separated from an adjacent outlet channel by a common porous wall. This filtering wall allows the exhaust gases to pass from an inlet channel to an outlet channel. The plurality of channels forms a honeycomb-type structure, as it is commonly known as in the field of particulate filters. This is because the channels are separated by common partitions in the manner of a honeycomb.

Each inlet channel and outlet channel has:
an open end having a cross section that is square in a plane orthogonal to the axis X,
a closed end,
a reference cross section of square shape in a plane orthogonal to the axis X, this section being situated between the two ends of the channel. Preferably, the square reference section is situated halfway between the inlet face and the outlet face.

The closed end has a zero section. Close to this closed end, in the portion of the channel situated between the reference section and the closed end, the section of the channel has a substantially cruciform shape in a plane orthogonal to the axis X.

Each of the four vertices of the square reference section is common to two inlet channels and two outlet channels. The four vertices of the square reference section have an unchanging position regardless of the section of the channel in a plane orthogonal to the axis X, in other words, each of the four vertices forms a line substantially parallel to the axis X between the inlet face and the outlet face of the filter.

These four points are highlighted in FIGS. 2, 3A, 5A and 7A, described below, which show the evolution in the section of a channel along the axis X for different geometries of channels of filters according to the invention.

In the rest of the description, the term cross section will be used to denote a section in a plane orthogonal to the axis X, unless specified otherwise.

The inlet face of the body of the filter has the contiguous open ends of the inlet channels, forming a grid pattern. Similarly, the outlet face of the body of the filter has the contiguous open ends of the outlet channels, likewise forming a grid pattern.

According to the invention, the geometry of each inlet and outlet channel is not constant along the entire length of the channel along the axis X, such that, for each inlet and outlet channel:
the perimeter of the section of the channel decreases continuously from the open end of the channel to the reference cross section of the channel, and then increases continuously from the reference cross section to the closed end, the closed end being excluded since the perimeter is zero at the closed end, and
the area of the section of the channel decreases uniformly along the axis X from the open end of the channel to the closed end, where said area is zero, the closed end of the channel being situated in the body of the filter close to the outlet face for the inlet channel and being situated in the body of the filter close to the inlet face for the outlet channel.

Thus, on account of this specific geometry, the inlet channels close before reaching the outlet face. Similarly, the outlet channels close before reaching the inlet face of the filter. The filter according to the invention can therefore do away with plugs for closing off one of the ends of the channels. Preferably, the closed end of the inlet channels is situated in the body of the filter at a distance yₑ from the outlet face of between 1 and 50 times the thickness of the walls. Similarly, the closed end of the outlet channels is situated in the body of the filter at a distance yₛ from the inlet face of between 1 and 50 times the thickness of the walls.

FIG. 2 is a schematic partial view of the inlet face of an example of the filter according to the invention. The inlet face 40 is in a plane YZ, orthogonal to the axis X. Solid lines indicate the openings of the inlet channels 20, of square section, forming a grid pattern. The square sections are “positioned” point down. The thickness of the walls delimiting the channels is not shown in the figure. The inlet channels, with an opening 20 of square section, positioned point down, extend through the body of the filter along the axis X, and close gradually close to the outlet face of the filter. Dashed lines indicate the reference cross sections of the inlet channels. Corresponding to four openings of square section on the inlet face, there are 4 square cross sections 21 (shown in gray). The square sections of the open ends are obtained by rotation, for example through an angle of 45° as shown, and by homothetic transformation by a positive ratio k, for example the root of 2 as shown, of the square reference cross section 21. The closed ends of the inlet channels are not shown in the figure. The vertices 23 of the square reference sections have an unchanging position regardless of the section of the channel in a plane orthogonal to the axis X. Regardless of the geometry of the channels of the filter according to the invention, this particular configuration of the unchanging vertices of the square reference section along X is present. The outlet face of the filter is formed in the same way, with the openings of the outlet channels, and can be drawn schematically as in FIG. 2. For each inlet and outlet channel, the square section of the open end is obtained by homothetic transformation by a positive ratio k, k preferably being equal to the root of 2, and by rotation, preferably through an angle of 45°, of the square reference cross section.

The inlet and outlet faces are formed only with openings in the inlet and outlet channels, respectively, which are contiguous and which form a grid pattern. In this way, the filter according to the invention affords an open frontal area (OFA) that is optimized compared with a prior art filter, for example as shown in FIGS. 1A and 1B. The OFA, defined by the ratio between the open area and the total inlet area of the filter and expressed in %, is a function of the thickness of the walls, of the size of the cells and of the density of the cells. While in the prior art the values commonly encountered range between 30 and 45%, the filter according to the present invention can have an OFA greater than 50%, preferably between 50 and 90%, more preferably between 60% and 90%, and even more preferably between 70% and 85%.

By virtue of this particular geometry of the channels, the filter according to the invention has a large filtering area, compared with the known prior art filters that have a similar number of channels and space requirement (volume), making it possible to improve the proportion of particles captured. Specifically, the increase in the filtering area is accompanied by a reduction in the speed of the exhaust gases through the walls, thereby improving the proportion of particles captured by the filter, and reduces the risk of captured particles being entrained again. The efficiency of the filter is thus improved.

The increase in the particle filtering area also reduces the pressure drop, also known as exhaust back-pressure. Specifically, the pressure drop is a function of the gas velocity, and with the velocity decreasing with the increase in the filtering area, the pressure drop also decreases.

Moreover, the absence of plugs and the large open frontal area (OFA) of the filter according to the invention help to reduce the back-pressure generated during the operation of the filter.

In conventional operation of a particulate filter, when the back-pressure exceeds a particular value, which may be the case when the filter is clogged with a large accumulation of particles, a filter regeneration phase has to be started. Thus, by limiting the pressure drop, the present invention can make it possible to space apart the filter regeneration phases.

The reduction in the pressure drop in the filter during operation also improves the efficiency of the engine. This is because, in the exhaust line of an internal combustion engine, the simple fact of introducing a particulate filter has the effect of increasing the pressure drop. The pressure drop increases with the gradual clogging of the filter due to the deposition of particles in the latter. The pressure drop causes an increase in the consumption of the engine, and this can lead to the latter being damaged in the case of overpressure. Thus, limiting the pressure drop associated with the use of a particulate filter makes it possible to avoid overconsumption of the engine or even damage to the latter.

In the filter according to the invention, all the inlet channels have an identical geometry. The same goes for all the outlet channels.

According to one embodiment, the reference cross section of each inlet and outlet channel is contained in one and the same reference plane orthogonal to the axis X, the reference plane being situated halfway between the inlet face and the outlet face.

The perimeter and the area of the section of the channels preferably evolve symmetrically on either side of the reference cross section. This is the case for example when the reference plane is situated halfway between the inlet face and the outlet face.

Preferably, the porous material that forms the body of the filter comprises at least one of the following ceramic materials: cordierite, silicon carbide, aluminum titanate. This list of materials is not limiting, and the body of the filter can be formed by any material suitable for the use of the particulate filter, that is to say any material with a porosity suitable for allowing through the exhaust gases while retaining the majority of the particles, and having physicochemical properties such that the filter can withstand the thermomechanical and chemical stresses associated with the use thereof in an exhaust line of an internal combustion engine. The material should also be suited to the methods for manufacturing the filter as described below.

Several channel geometries comply with the definition of a particular evolving geometry of the channels along the filter according to the invention.

Preferably, each inlet and outlet channel has a polygonal section of order 4n in every plane orthogonal to the axis X between the open end and the reference cross section, for the one part, and between the reference cross section and the closed end, for the other part, n being an integer preferably between 2 and 4.

The polygonal section of order 4n preferably forms a convex polygon between the open end and the reference cross section, and is preferably a concave polygon between the reference cross section and the closed end.

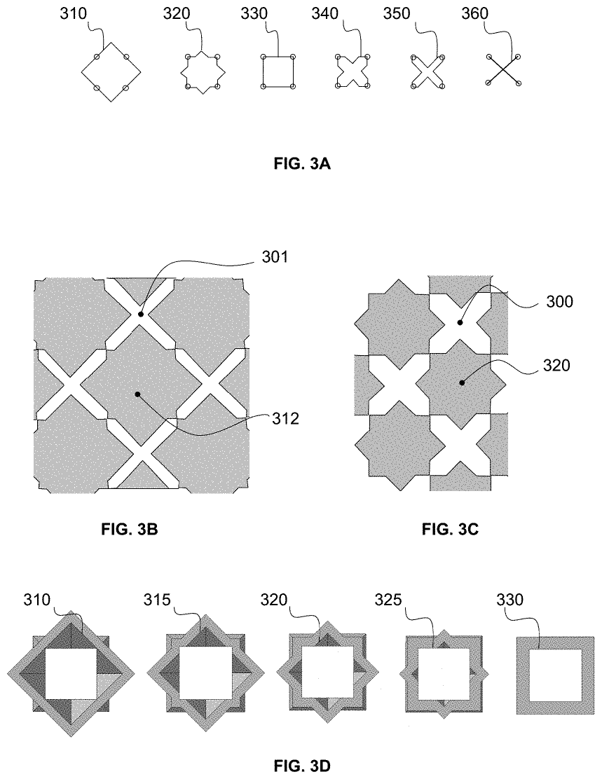

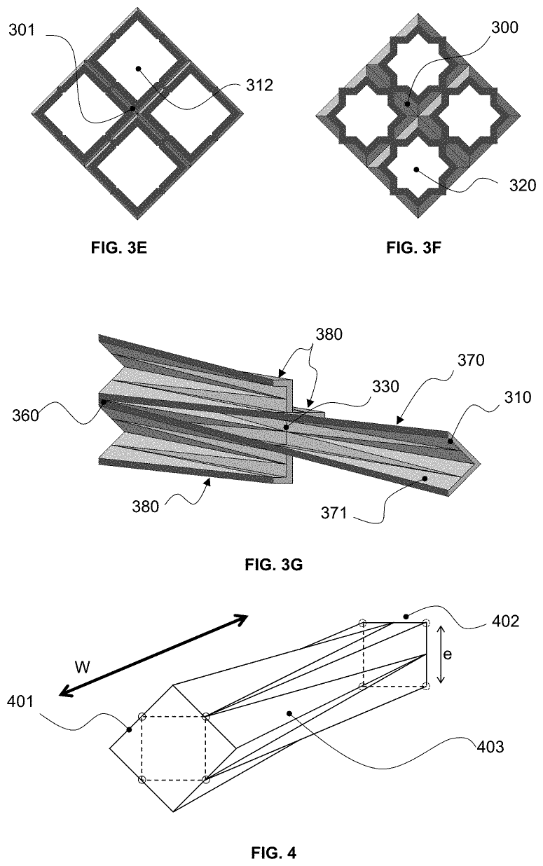

According to a preferred embodiment, shown in FIGS. 3A, 3B and 3C, the filter has channels with an evolving hexadecagonal geometry.

According to this embodiment, the section of the inlet and outlet channels is hexadecagonal (polygon of order 16) in every plane orthogonal to the axis X between the open and closed ends of each channel, except for the reference cross section. Such a filter has a larger filtering area compared with the other geometries according to the invention that have polygonal sections of smaller order.

Preferably, the section has the form of a convex polygon between the open end and the reference cross section, and the form of a concave polygon between the reference cross section and the closed end.

FIG. 3A illustrates the evolution of the cross section of an inlet channel according to this embodiment, from its open end to its closed end. The section 310 corresponds to the square inlet section, positioned point down. The section 330 corresponds to the square reference cross section, preferably situated halfway between the inlet and outlet faces of the filter body. The four unchanging vertices of the square reference cross section 330 are shown on each section 310 to 360. For example, the section of the open end 310 is obtained by rotation, preferably through 45°, and by homothetic transformation with a positive ratio k, of the reference section 330. The section 320 is an intermediate section between the section 310 and the section 330, for example at a distance of around ¼ of the length of the filter starting from the inlet face. The section 350 is a section of the channel close to the outlet face of the filter. The section 340 is an intermediate section between the reference section 330 and the section 350, for example at a distance of around ¾ of the length of the filter starting from the inlet face. Finally, the section 360 illustrates a section of the channel just before the closure of the latter, having a substantially cruciform shape.

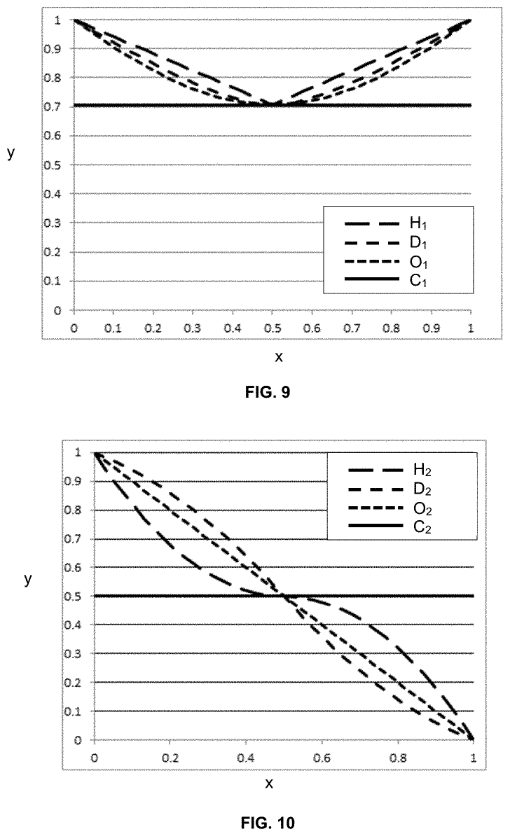

It is apparent that the perimeter of the section decreases from the open end 310 to the reference cross section 330, and then increases again, symmetrically, from the reference section 330 to the closed end, where the perimeter is zero. This evolution of the perimeter is also illustrated in the graph in FIG. 9 by the dashed curve denoted H₁. The distance from the inlet of the filter (origin) to the outlet of the filter is shown on the x-axis, and the perimeter of the section of the channel is shown on the y-axis. The values are expressed without dimensions. The graph has been drawn for a filter with channels of square reference section with a side length of 1.27 mm. By way of comparison, the solid curve C₁ has been plotted, representing the perimeter of the section of a channel having a constant square section along the entire length of the channel (square section with a side length of 1.27 mm). According to the example illustrated in FIG. 9, the reference section is situated halfway between the inlet and outlet faces. The perimeter at the closed end, which is zero, is not shown in this figure. The outlet channel evolves in the same way from the outlet face, which in this case would be the origin of the graph, to the inlet face of the filter.

It is also apparent that the area of the section decreases uniformly along the axis X from the open end 310 of the channel to the closed end 360, wherein said area is zero. The evolution of the area of the section of the channel along the channel is also shown in the graph in FIG. 10 by the dashed curve denoted H₂. The distance from the inlet of the filter (origin) to the outlet of the filter is shown on the x-axis, and the area of the section of the channel is shown on the y-axis. The values are expressed without dimensions. The graph has been drawn for a filter with channels of square reference section with a side length of 1.27 mm. By way of comparison, the solid curve C₂ has been plotted, representing the evolution of the area of the section of a channel having a constant square section along the entire length of the channel (square section with a side length of 1.27 mm). According to the example illustrated in FIG. 10, the reference section is situated halfway between the inlet and outlet faces. The outlet channel evolves in the same way from the outlet face, which in this case would be the origin of the graph, to the inlet face of the filter.

FIG. 3D illustrates, like FIG. 3A, the evolution of the cross section of an inlet channel of the filter, but this time in the form of front views of the channel in section in a plane orthogonal to the axis X, with a depiction of the thickness of the walls, and from its open end to the reference cross section. The sections 310, 320 and 330 are the same as those described with respect to FIG. 3A. The section 315 is halfway between the section of the open end 310 and the section 320, just as the section 325 is halfway between the section 320 and the reference section 330.

FIGS. 3B and 3C are schematic partial cross sections of the filter with an evolving hexadecagonal geometry. FIGS. 3E and 3F are similar to FIGS. 3B and 3C, except that the thickness of the walls of the channels is shown. FIGS. 3B and 3E correspond to sections made close to the inlet of the filter, showing the sections of the inlet channels 312 and those of the outlet channels 301, having complementary shapes. FIGS. 3C and 3F correspond to sections made between the inlet face of the filter and the reference section, for example around ¼ of the way along the filter from the inlet face, showing the sections of the inlet channels 320 and those of the outlet channels 300, having complementary shapes. The perimeter and the area of the section of the inlet channel 312 are larger than the perimeter and the area of the section 320.

FIG. 3G is a partial view of a longitudinal section of the filter according to this embodiment having a hexadecagonal geometry along the axis X, in which an inlet channel 370 shown surrounded by four outlet channels 380 can be seen. The inlet channel 370 has an open end of square section 310 at the inlet face of the body of the filter. The channel 370 closes at its other end 360 before reaching the outlet face of the body of the filter. The wall which separates the channel 370 from the adjacent channels has 16 facets 371 that form a hexadecagon in cross section, except for at the open end 310 and closed end 360 and at the square reference cross section 330.

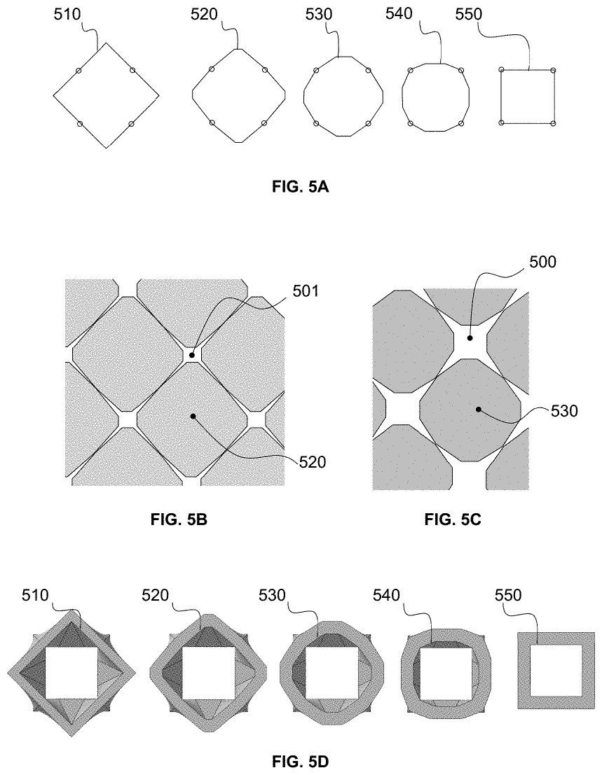

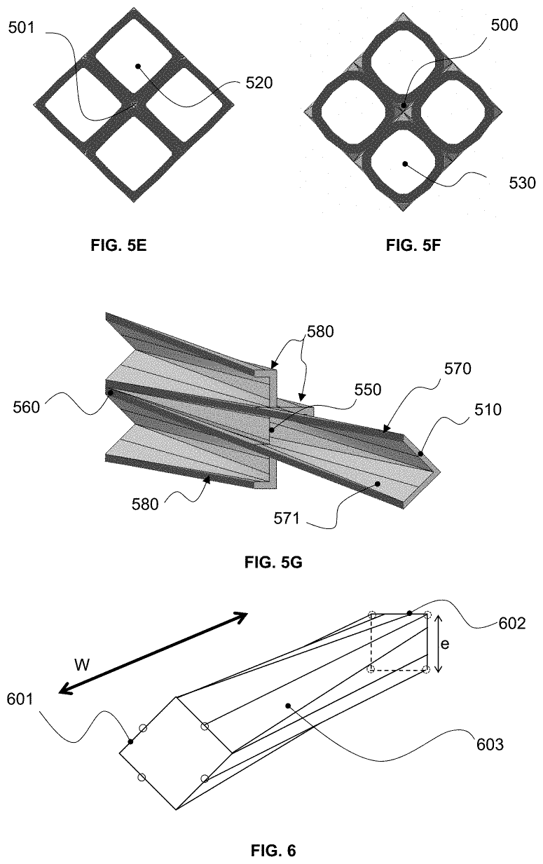

According to another embodiment, shown in FIGS. 5A, 5B and 5C, the filter has channels with an evolving dodecagonal geometry.

According to this embodiment, the section of the inlet and outlet channels is dodecagonal (polygon of order 12) in every plane orthogonal to the axis X between the open and closed ends of each channel, except for the reference cross section.

The section preferably has the form of a convex polygon between the open end and the reference cross section, and the form of a concave polygon between the reference cross section and the closed end.

FIG. 5A illustrates the evolution of the cross section of an inlet channel according to this embodiment, from its open end to the reference cross section. The section 510 corresponds to the square inlet section, positioned point down. The section 550 corresponds to the square reference cross section, preferably situated halfway between the inlet and outlet faces of the filter body. The four unchanging vertices of the square reference cross section 550 are shown in each depicted section 510, 520, 530, 540 and 550. For example, the section of the open end 510 is obtained by rotation, preferably through 45°, and by homothetic transformation with a positive ratio k, of the reference section 550. The sections 520, 530 and 540 are intermediate sections between the section of the open end 510 and the reference section 550, for example at regular intervals between the inlet face of the filter and the reference section of a channel.

It is apparent that the perimeter of the section decreases from the open end 510 to the position of the reference cross section 550. The evolution from the reference section to the closed end of the channel is not illustrated. The evolution of the perimeter is also shown in the graph in FIG. 9, along the entire length of the channel this time, with the dashed curve denoted D₁. The distance from the inlet of the filter (origin) to the outlet of the filter is shown on the x-axis, and the perimeter of the section of the channel is shown on the y-axis. The values are expressed without dimensions. The graph has been drawn for a filter with channels of square reference section with a side length of 1.27 mm. according to the example illustrated in FIG. 9, the reference section is situated halfway between the inlet and outlet faces. In FIG. 9, the perimeter at the closed end, which is zero, is not shown. The outlet channel evolves in the same way from the outlet face, which in this case would be the origin of the graph, to the inlet face of the filter.

It is also apparent that the area of the section decreases uniformly along the axis X from the open end 510 of the channel to the position of the reference cross section 550. The evolution of the area of the section of the channel along the channel is also shown in the graph in FIG. 10 by the dashed curve denoted D₂. The distance from the inlet of the filter (origin) to the outlet of the filter is shown on the x-axis, and the area of the section of the channel is shown on the y-axis. The values are expressed without dimensions. The graph has been drawn for a filter with channels of square reference section with a side length of 1.27 mm. According to the example illustrated in FIG. 10, the reference section is situated halfway between the inlet and outlet faces. The outlet channel evolves in the same way from the outlet face, which in this case would be the origin of the graph, to the inlet face of the filter.

FIG. 5D illustrates, like FIG. 5A, the evolution of the cross section of an inlet channel of the filter, but this time in the form of front views of the channel in section in a plane orthogonal to the axis X, with a depiction of the thickness of the walls. The same references as those in FIG. 5A are used to represent the similar sections.

FIGS. 5B and 5C are schematic partial cross sections of the filter with an evolving dodecagonal geometry. FIGS. 5E and 5F are similar to FIGS. 3B and 3C, except that the thickness of the walls of the channels is shown. FIGS. 5B and 5E correspond to sections made close to the inlet of the filter, showing the dodecagonal sections of the inlet channels 520 and those of the outlet channels 501, having complementary shapes. FIGS. 5C and 5F correspond to sections made between the inlet face of the filter and the reference section, for example halfway between the inlet face and the reference section, showing the dodecagonal sections of the inlet channels 530 and those of the outlet channels 500, having complementary shapes. The perimeter and the area of the section of the inlet channel 520 are larger than the perimeter and the area of the section of the inlet channel 530.

FIG. 5G is a partial view of a longitudinal section of the filter according to this embodiment having a dodecagonal geometry along the axis X, in which an inlet channel 570 shown surrounded by four outlet channels 580 can be seen. The inlet channel 570 has an open end of square section 510 at the inlet face of the body of the filter. The channel 570 closes at its other end 560 before reaching the outlet face of the body of the filter. The wall which separates the channel 570 from the adjacent channels has 12 facets 571 that form a hexadecagon in cross section, except for at the open end 510 and closed end 560 and at the square reference cross section 550.

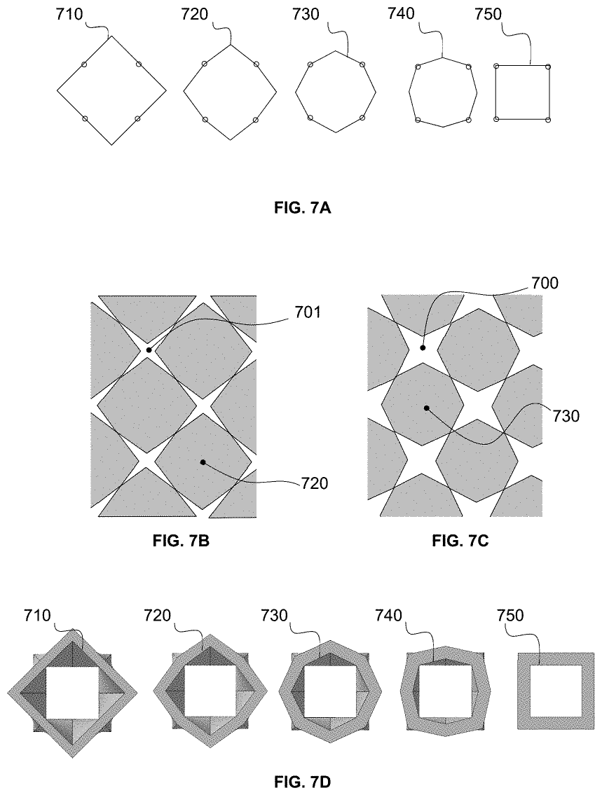

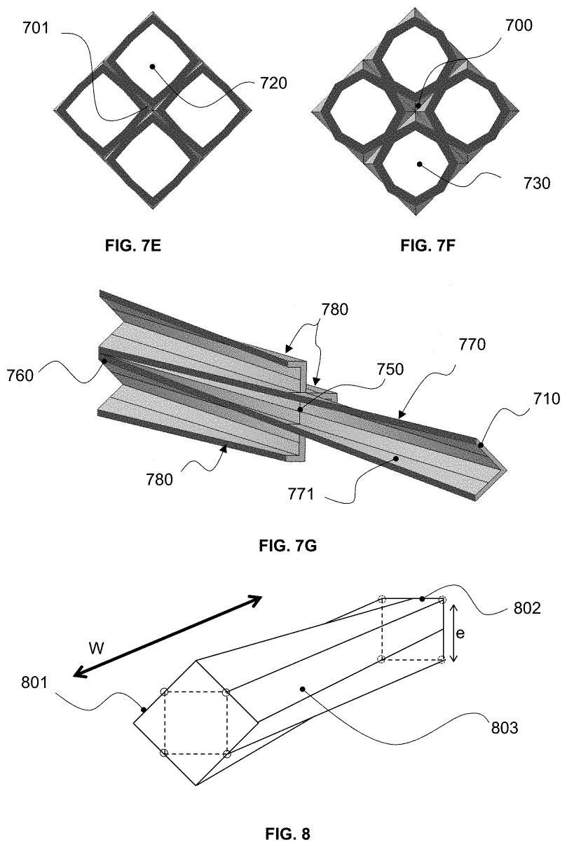

According to another embodiment, shown in FIGS. 7A, 7B and 7C, the filter has channels with an evolving octagonal geometry.

The filter is identical to the one described with respect to FIGS. 5A to 5C, except that the channels have octagonal sections (polygon of order 8) in a plane orthogonal to the axis X between the open and closed ends of each channel, apart from the reference cross section, which is square.

The section preferably has the form of a convex polygon between the open end and the reference cross section, and the form of a concave polygon between the reference cross section and the closed end.

The sections 710, 720, 730, 740 and 750 in FIG. 7A are equivalent to the sections in FIG. 5A for an octagonal geometry, illustrating the evolution of the cross section of an inlet channel from its open end to the reference cross section. The description of the filter with respect to FIG. 7A is similar to that for FIG. 5A, apart from the form of the section, which is octagonal rather than dodecagonal, and is not repeated here.

FIG. 7D illustrates, like FIG. 7A, the evolution of the cross section of an inlet channel of the filter, but this time in the form of front views of the channel in section in a plane orthogonal to the axis X, with a depiction of the thickness of the walls. The same references as those in FIG. 7A are used to represent the similar sections.

The same goes for FIGS. 7B/7E and 7C/7F. The partial schematic cross sections of the filter according to these figures can be described in the same way as those in FIGS. 5B/5E and 5C/5F, except that the sections of the inlet and outlet channels have an octagonal form which evolves along the axis X, while in FIGS. 5B/5E and 5C/5F, the geometry is dodecagonal. The sections of the inlet channels 720 and 730 have a form complementary to that of the sections of outlet channels 701 and 700, respectively.

In FIGS. 9 and 10, it is also possible to see the evolution of the perimeter and the area of the section of an inlet channel, respectively, with the dashed curves denoted O. It is apparent that the perimeter of the section decreases from the open end (710 in FIG. 7A) to the position of the reference cross section (750 in FIG. 7A), and then increases again, symmetrically, from the reference section to the closed end, where the perimeter is zero (zero perimeter not shown). It is also clear that the area of the section decreases uniformly along the axis X from the open end of the channel to the position of the reference cross section, and then as far as the closed end of the channel (zero area). The curves O₁ have been drawn for a filter with channels of square reference section with a side length of 1.27 mm. The outlet channel evolves in the same way from the outlet face, which in this case would be the origin of the graph, to the inlet face of the filter.

FIG. 7G is a partial view of a longitudinal section of the filter according to this embodiment having an evolving octagonal geometry along the axis X, in which an inlet channel 770 shown surrounded by four outlet channels 780 can be seen. The inlet channel 770 has an open end of square section 710 at the inlet face of the body of the filter. The channel 770 closes at its other end 760 before reaching the outlet face of the body of the filter. The wall which separates the channel 770 from the adjacent channels has 8 facets 771 that form a hexadecagon in cross section, except for at the open end 710 and closed end 760 and at the square reference cross section 750.

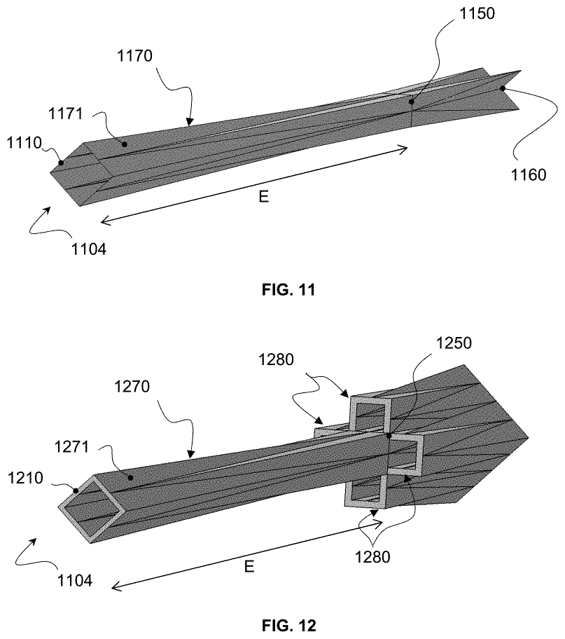

FIG. 11 shows a channel 1170 of a filter according to another embodiment of the invention, in which the filter has an asymmetric structure: the reference section 1150 of the channel is not situated halfway between the inlet face and the outlet face of the body of the filter, but is situated at a given distance E from the inlet face 1104 of the body of the filter. In this embodiment, the perimeter and the area of the cross section of the channels does not evolve symmetrically on either side of the reference section. Although the channel 1170 shown in FIG. 11 has an evolving hexadecagonal geometry along the axis X, this asymmetric embodiment can have other geometries as described above. The wall which separates the channel 1170 from the adjacent channels (not shown) thus has 16 facets 1171 that form a hexadecagon in cross section, except for at the open end 1110 and closed end 1160 and at the square reference cross section 1150. This embodiment makes it possible to create asymmetry between the inlet and outlet channels, notably to increase the overall volume created by the inlet channels relative to that created by the outlet channels, so as to preserve a large volume of the inlet channels even when the filter is filled with particles or combustion residues thereof (ash) and thus to reduce the pressure drop generated.

FIG. 12 illustrates the same embodiment as that shown in FIG. 11, except that an inlet channel 1270 with the four adjacent outlet channels 1280, and the thickness of the walls of the channels are shown. The inlet channel 1270 has an evolving hexadecagonal geometry along the axis X, with a wall which separates it from the adjacent channels 1280 thus having 16 facets 1271 that form a hexadecagon in cross section, except for at the open end 1210 and closed end (not visible in the view) and at the square reference cross section 1250.

Without departing from the scope of the present invention, the filter can have channels comprising curved walls, in the manner of the filters described in the patent applications FR2959673 and FR2912069. In this case, the cross sections of the channels are in the form of deformed polygons with segments between the vertices which are curved, having, for each segment, one curvature point or several curvature points (undulations). It is thus possible to create asymmetry between the inlet and outlet channels, for example with inlet channels having cross sections with concave segments and outlet channels with cross sections having a complementary form with convex segments. Such a channel geometry makes it possible notably to increase the overall volume created by the inlet channels relative to that created by the outlet channels, so as to preserve a large volume of the inlet channels even when the filter is filled with particles or combustion residues thereof (ash) and thus to reduce the pressure drop generated.

According to another aspect, the invention proposes providing a method for manufacturing the described filter.

The particular geometries described in detail above can be obtained by different manufacturing methods.

A first method for manufacturing the filter is an additive manufacturing method based on a particular 3D printing technique which is stereolithography. According to this method, the body of the filter is constructed by solidifying a porous material in the form of successive layers by means of a stereolithography machine which reproduces a previously established digital 3D model of said filter body.

Stereolithography is a well-known technique for rapid prototyping. This technique can advantageously be applied to the manufacturing of the filter according to the invention, which has a complex channel geometry.

According to another manufacturing method, the filter according to the invention is manufactured using 3D printing technology, in which the body of the filter is constructed by deposition of a porous material in the form of successive layers by means of a 3D printer which reproduces a previously established digital 3D model of said filter body.

The 3D printing technique, employing the deposition of a material, typically in the form of a spool, and passing through a heated extrusion die, is likewise well known in the industrial field.

Such manufacturing methods using 3D printing (stereolithography or 3D printing by deposition of material) are easier to implement than filter manufacturing methods by extrusion that include steps of closing off the channels by producing a plug and/or deforming the channels, and also make it possible to achieve greater precision in the structure of the filter manufactured.

A third manufacturing method consists in deforming the channels, on the basis of the manufacturing principle described in the patent application WO9422556, but using a specific tool that penetrates through the inlet and outlet faces of the particulate filter.

This manufacturing method comprises the following steps:
a filter body made of porous material that extends in an elongate manner along an axis X is obtained by extrusion, said filter body having a plurality of initial channels that extend parallel to the axis X and have a constant section that is square orthogonally to the axis X, and open at their two ends onto the inlet face and the outlet face of said body, and
the initial channels are deformed by introducing a penetrating tool into the initial channels through one of their ends at each of the inlet and outlet faces, and as far as a given point D along the axis X, at least as far as the middle of said body, so as to obtain the inlet and outlet channels of the filter according to the invention, having an evolving polygonal geometry.

The penetrating tool preferably has a block provided with a set of polyhedral protrusions that extend in an elongate manner along one and the same axis W. The protrusions have a first square base and a second square base that are situated in parallel planes, the first base being in contact with the block, the first and second bases being connected by 4n facets, n being an integer preferably between 2 and 4, such that the section of the protrusion in a plane orthogonal to the axis W is in the form of an evolving convex polygon of order 4n, preferably such that the perimeter of the section of the protrusion decreases continuously from the first base to the second base at the same time as the area of said section of the protrusion decreases uniformly from the first base to the second base.

The penetrating tool and the body of the filter are configured such that when the penetrating tool is applied to each of the inlet and outlet faces of the body of the filter, the protrusions pass into every other channel on each face in a checkerboard pattern.

In the case of a filter having an evolving hexadecagonal geometry, as illustrated in FIGS. 3A to 3G, the geometry of the channels can be obtained by deformation of an initial structure having channels of square section as shown in FIGS. 1A and 1B, that are open at each face of the filter, with the aid of a penetrating tool, a protrusion of which is illustrated in FIG. 4. The polyhedral protrusion having 16 faces extends in an elongate manner along the axis W, and has a first square base 401 and a second square base 402 that are situated in parallel planes. The first base 401 is in contact with a block (not shown). The square bases 401 and 402 are connected by 16 facets 403 such that the section of the protrusion in a plane orthogonal to the axis W is in the form of an evolving irregular convex polygon of order 16 (4×n where n is equal to 4), preferably such that the perimeter of the section of the protrusion decreases continuously from the first base 401 to the second base 402 at the same time as the area of said section of the protrusion decreases uniformly from the first base 401 to the second base 402.

In the case of a filter having an evolving dodecagonal geometry, as illustrated in FIGS. 5A to 5G, the geometry of the channels can be obtained by deformation of an initial structure having channels of square section as shown in FIGS. 1A and 1B, that are open at each face of the filter, with the aid of a penetrating tool, a protrusion of which is illustrated in FIG. 6. The polyhedral protrusion having 12 faces extends in an elongate manner along the axis W, and has a first square base 601 and a second square base 602 that are situated in parallel planes. The first base 601 is in contact with a block (not shown). The square bases 601 and 602 are connected by 12 facets 603 such that the section of the protrusion in a plane orthogonal to the axis W is in the form of an evolving irregular convex polygon of order 12 (4×n where n is equal to 2), preferably such that the perimeter of the section of the protrusion decreases continuously from the first base 601 to the second base 602 at the same time as the area of said section of the protrusion decreases uniformly from the first base 601 to the second base 602.

In the case of a filter having an evolving octagonal geometry, as illustrated in FIGS. 7A to 7G, the geometry of the channels can be obtained by deformation of an initial structure having channels of square section as shown in FIGS. 1A and 1B, that are open at each face of the filter, with the aid of a penetrating tool, a protrusion of which is illustrated in FIG. 8. The polyhedral protrusion having 8 faces extends in an elongate manner along the axis W, and has a first square base 801 and a second square base 802 that are situated in parallel planes. The first base 801 is in contact with a block (not shown). The square bases 801 and 802 are connected by 8 facets 803 such that the section of the protrusion in a plane orthogonal to the axis W is in the form of an evolving irregular convex polygon of order 8 (4×n where n is equal to 1), preferably such that the perimeter of the section of the protrusion decreases continuously from the first base 801 to the second base 802 at the same time as the area of said section of the protrusion decreases uniformly from the first base 801 to the second base 802.

The penetrating tools having protrusions with an evolving polygonal geometry as described can be manufactured by different methods: molding, machining, 3D printing, etc.

### Examples

The following examples, which are derived from calculations, illustrate the gains in terms of filtering area or in terms of space requirement (volume of the filter) of examples of filters according to the invention, compared with a conventional filter having channels with a constant square cross section. The thickness of the walls is not taken into consideration.

Take for example a conventional particulate filter having 400 channels per square inch. The channels have a constant square section orthogonally to the axis X, the side length of which is 1.27 mm. The length of the channels is 152.4 mm (6″). The filtering area is 774 mm².

Still by way of example, let us consider a filter according to the invention having an evolving polygonal geometry along the entire length of the channel, of which the square inlet section of the channel has a side that is longer by a factor of the root of 2 compared with the side of the square section of the conventional filter, i.e. a square section of the open end of side length 1.27×1.414=1.80 mm.

In the case in which the channels have an evolving hexadecagonal geometry, as described with respect to FIGS. 3A to 3C, with a square reference cross section of side length e=1.27 mm, the filtering area reaches 934 mm², i.e. more than 20% greater than the filtering area of the conventional filter. For the same performance, the volume of the particulate filter according to the invention can therefore be reduced by around 17%.

In the case in which the channels have an evolving dodecagonal geometry, as described with respect to FIGS. 5A to 5C, with a square reference cross section of side length e=1.27 mm, the filtering area reaches 909 mm², i.e. more than 17% greater than the filtering area of the conventional filter. For the same performance, the volume of the particulate filter according to the invention can therefore be reduced by around 15%.

In the case in which the channels have an evolving octagonal geometry, as described with respect to FIGS. 7A to 7C, with a square reference cross section of side length e=1.27 mm, the filtering area reaches 894 mm², i.e. more than 15% greater than the filtering area of the conventional filter. For the same performance, the volume of the particulate filter according to the invention can therefore be reduced by around 13%.

For the same performance, the reductions in volume that are allowed reduce the material cost, the weight, the space requirement or, with the same volume, the reduction in the pressure drop and the improvement in the proportion of particles captured, on account of the reduction in the speeds at which the gases pass through.

The total length of the particulate filter according to the invention can be reduced:
by a factor of 1.17 for the exemplified evolving hexadecagonal geometry, taking it from 152.4 mm (6″) for a conventional filter to 130 mm.
by a factor of 1.15 for the exemplified evolving dodecagonal geometry, taking it from 152.4 mm (6″) to 132.5 mm,
by a factor of 1.13 for the exemplified evolving octagonal geometry, taking it from 152.4 mm (6″) to 135 mm.

1. A particulate filter for collecting the particles of exhaust gases from a combustion engine, said filter having a (monolithic) body made of porous material that extends in an elongate manner along an axis X, said body comprising:
an inlet face through which the exhaust gases enter the filter,
an outlet face through which the exhaust gases exit the filter again,
a plurality of inlet channels and outlet channels extending between the inlet face and the outlet face parallel to the axis X, each inlet channel being separated from an adjacent outlet channel by a common filtering wall that is able to allow through the exhaust gases, in order to form a honeycomb-type structure, the inlet and outlet channels each having:
an open end with a cross section that is square orthogonally to the axis X,
a closed end,
a reference cross section that is square orthogonally to the axis X, situated between said open and closed ends, preferably situated halfway between the inlet face and the outlet face, each of the four vertices of the reference cross section being common to two inlet channels and two outlet channels, and the four vertices of the square reference cross section having an unchanging position for every section of the channel orthogonally to the axis X,
the open ends of the inlet channels being contiguous at the inlet face and the open ends of the outlet channels being contiguous at the outlet face, said open ends forming a grid pattern,
wherein the geometry of each inlet and outlet channel is not constant along the entire length of the channel along the axis X, such that, for each inlet and outlet channel:
the perimeter of the section of the channel decreases continuously from the open end of the channel to the reference cross section of said channel, and then increases continuously from said reference cross section to the closed end, and
the area of the section of the channel decreases uniformly along the axis X from the open end of the channel to the closed end, where said area is zero, said closed end being situated in the body of the filter close to the outlet face for the inlet channel and being situated in the body of the filter close to the inlet face for the outlet channel.

2. The filter as claimed in claim 1, wherein each inlet and outlet channel has a polygonal section of order 4n in every plane orthogonal to the axis X between the open end and the reference cross section, for the one part, and between the reference cross section and the closed end, for the other part, n being an integer preferably between 2 and 4.

3. The filter as claimed in claim 2, wherein the polygonal section of order 4n forms a convex polygon between the open end and the reference cross section, and is a concave polygon between the reference cross section and the closed end.

4. The filter as claimed in claim 1, wherein the section of the inlet and outlet channels is octagonal orthogonally to the axis X between the open end and closed end of each channel, except for the reference cross section.

5. The filter as claimed in claim 1, wherein the section of the inlet and outlet channels is dodecagonal orthogonally to the axis X between the open end and closed end of each channel, except for the reference cross section.

6. The filter as claimed in claim 1, wherein the section of the inlet and outlet channels is hexadecagonal orthogonally to the axis X between the open end and closed end of each channel, except for the reference cross section.

7. The filter as claimed in claim 1, wherein, for each inlet and outlet channel, the square section of the open end X is obtained by homothetic transformation by a positive ratio k, k preferably being equal to the root of 2, and by rotation, preferably through an angle of 45°, of the square reference cross section.

8. The filter as claimed in claim 1, wherein the closed end of the inlet channels is situated in the body of the filter at a distance ye from the outlet face, and wherein the closed end of the outlet channels is situated in the body of the filter at a distance ys from the inlet face, the distances ye and ys being between 1 and 50 times the thickness of the walls.

9. The filter as claimed in claim 1, wherein the reference cross section of each inlet and outlet channel is contained in one and the same reference plane orthogonal to the axis X, the reference plane being situated halfway between the inlet face and the outlet face.

10. The filter as claimed in claim 1, wherein the perimeter and the area of the section of the channels evolve symmetrically on either side of the reference cross section.

11. The filter as claimed in claim 1, wherein the reference cross section of each inlet and outlet channel is contained in one and the same reference plane orthogonal to the axis X, the reference plane being closer to the outlet face than to the inlet face.

12. The filter as claimed in claim 1, wherein the common filtering walls separating the inlet and outlet channels comprise a catalytic coating for the treatment of at least one compound contained in the exhaust gases, the compound being chosen from the following list: unburned hydrocarbons, carbon monoxide, nitrogen oxides, NH3, SO2, H2S.

13. A method for manufacturing a particulate filter as claimed in claim 1 by stereolithography, wherein the body of the filter is constructed by solidifying a porous material in the form of successive layers by means of a stereolithography machine which reproduces a previously established digital 3D model of the filter body.

14. A method for manufacturing a particulate filter as claimed in claim 1 by 3D printing, wherein the body of the filter is constructed by deposition of a porous material in the form of successive layers by means of a 3D printer which reproduces a previously established digital 3D model of the filter body.

15. A method for manufacturing a particulate filter as claimed in claim 1, wherein:
a filter body made of porous material that extends in an elongate manner along an axis X is obtained by extrusion, the filter body having a plurality of initial channels that extend parallel to the axis X and have a constant section that is square orthogonally to the axis X, and open at their two ends onto the inlet face and the outlet face of the body, and
the initial channels are deformed by introducing a penetrating tool into the initial channels through one of their ends at each of the inlet and outlet faces, and as far as a given point D along the axis X, at least as far as the middle of the body, so as to obtain the inlet and outlet channels of the filter as claimed in claim 1.

16. The manufacturing method as claimed in claim 15, wherein:
the penetrating tool has a block provided with a set of polyhedral protrusions that extend in an elongate manner along one and the same axis W, the protrusions having a first square base and a second square base that are situated in parallel planes, the first base being in contact with the block, the first and second bases being connected by 4n facets, n being an integer preferably between 2 and 4, such that the section of the protrusion in a plane orthogonal to the axis W is in the form of an evolving irregular convex polygon of order 4n, preferably such that the perimeter of the section of the protrusion decreases continuously from the first base to the second base at the same time as the area of the section of the protrusion decreases uniformly from the first base to the second base, and
the penetrating tool and the body of the filter being configured such that when the penetrating tool is applied to each of the inlet and outlet faces of the body of the filter, the protrusions pass into every other channel on each face in a checkerboard pattern.
